(19) United States
(12) Patent Application Publication
(10) Pub. No.: US 2025/0330899 A1
(43) Pub. Date: Oct. 23, 2025

(54) NETWORK MESSAGING DOMAIN SELECTION

(71) Applicant: T-MOBILE INNOVATIONS LLC, Overland Park, KS (US)

(72) Inventors: A. Karl Corona, Maple Valley, WA (US); Ayman Zaki, Renton, WA (US); Sean Patrick Hoelzle, Collegeville, PA (US)

(21) Appl. No.: 18/638,442

(22) Filed: Apr. 17, 2024

(51) Int. Cl. H04W 48/18; H04W 8/08; H04W 84/04; H04W 84/06

(52) U.S. Cl. CPC H04W 48/18; H04W 8/082; H04W 84/042; H04W 84/06

(57) ABSTRACT

The technology disclosed herein relates to network messaging domain selection for the improvement of radio resources, bandwidth, and user device experiences. In embodiments, one or more particular queries can be transmitted (e.g., to a Home Subscriber Server) associated with a user device receiving or transmitting a message. For example, one of these particular queries (e.g., a Diameter Sh interface query) can include a request for particular location information (e.g., a cell identity associated with a base station, a radio access technology type, a public land mobile network identity) associated with the user device receiving or transmitting the message (e.g., a short message service). The technology discussed herein can determine whether the message is to be delivered via non-access stratum or internet protocol multimedia subsystem.

### SUMMARY

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, particular determinations can be made (e.g., by a messaging application server) with respect to delivering one or more messages (e.g., a short message service (SMS)) to a user device via non-access stratum (NAS) or internet protocol multimedia subsystem (IMS) using particular location information associated with the message. For example, the systems, devices, and methods herein may receive a message to be delivered to a user device, and a query (e.g., a Diameter Sh interface query) may be subsequently transmitted (e.g., to a Home Subscriber Server (HSS)) for the particular location information. This particular location information may include one or more of a public land mobile network identity (PLMN ID), a cell identity associated with a network or portion thereof, a radio access technology (RAT) type, another type of location information, or one or more combinations thereof.

Based on this particular location information, the systems, devices, and methods herein can determine whether the message is to be delivered via NAS or IMS. By way of example, an instruction to deliver the message via NAS can be transmitted based on the particular location information (e.g., cell identity) indicating that the recipient user device, the transmitting user device, or both, has a roaming status. As another example, the instruction to deliver the message via NAS can be transmitted based on the particular location information (e.g., RAT type) indicating that the recipient user device is accessing a terrestrial network (e.g., a core network) via a satellite. In yet another example, the instruction to deliver the message via NAS can be transmitted based on the PLMN ID of the recipient user device corresponding to a PLMN ID other than a home PLMN ID. As another example, the instruction to deliver the message via IMS can be transmitted based on the PLMN ID of the recipient user device corresponding to the home PLMN ID for the recipient user device.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example operating environment for general network messaging, in accordance with embodiments herein;

FIG. 2 depicts an example operating environment for network messaging domain selection, in accordance with embodiments herein;

FIG. 3 illustrates an example flowchart for network messaging domain selection, in accordance with aspects herein; and

FIG. 4 depicts an example user device suitable for use in implementations of the present disclosure, in accordance with aspects herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present invention can be embodied in many different forms and should not be construed as limited to the aspects set forth herein.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term a “communication service” provided by a base station or access point may be synonymous with network access technology (NAT), a communication protocol and umbrella term used to refer to the particular technological standard/protocol that governs a communication associated with user equipment (UE). Examples may include 3G, 4G, 5G, 6G, another generation technology, 802.11x, etc., or one or more combinations thereof. The term “access point” is used to refer to an access point that transmits signals to a UE and receives signals from the UE in order to allow the UE to connect to a broader data or cellular network (including by way of one or more intermediary networks, gateways, or the like).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

By way of background, there are instances in which one or more components of a network are unaware of particular location information when providing a communication service for a user device. For example, when delivering Short Message Service (SMS) messages, the network is not aware of particular location information (e.g., Public Land Mobile Network ID (PLMN ID), such as a five to six-digit number identifying a country and mobile network operator via a Mobile Country Code (MCC) and Mobile Network Code (MNC)). For instance, in the case of a roaming scenario, there may be limited radio resources and a carrier may need to determine how, if at all, the message will be delivered. In current messaging solutions, the terminating messaging application server is not able to determine or make such a location based delivery decision and will typically use internet protocol multimedia subsystem (IMS) by default.

Embodiments of the technology discussed herein provide various improvements to the prior technologies and methods discussed above associated with the network being unaware of the particular location information. For example, embodiments of the presently disclosed technology can enhance network functionality and communication services via messaging application server(s) (or another type of server) by causing the messaging application server to query (e.g., a Home Subscriber Server (HSS)) for particular location information so that the messaging application server can use the queried location information to select SMSoIP delivery, SMSoNAS delivery, another type of delivery, one or more combinations thereof, or determine not deliver the message (e.g., not to deliver at all or not to deliver until the user device location changes, such as by storing and then forwarding, by discarding, performing another type of response option, etc.). To illustrate, in a satellite supported network, the carrier may want to utilize Short Message Service over non-access stratum (SMSoNAS) instead of SMSoIP to preserver radio resources associated with the SMSoIP.

In some additional examples, embodiments of the disclosed mechanisms for the messaging application server to determine the particular location information (e.g., by querying the HSS) may include particular and enhanced Diameter Sh interface queries, the general Diameter Sh interface protocols being described in 3GPP (e.g., ETSI TS 129 329 V15.2.0 (2019 October), which is incorporated herein by reference) and GSMA references (e.g., NG.111-v2.0, which is incorporated herein by reference). The technology disclosed herein, including the location-based routing decisions, may result in improved message delivery success rates, better utilization of radio resources, increased capacity for additional devices on limited bandwidth networks (such as non-terrestrial based radio networks), as well as other network and communication service improvements.

### Example Operating Environments

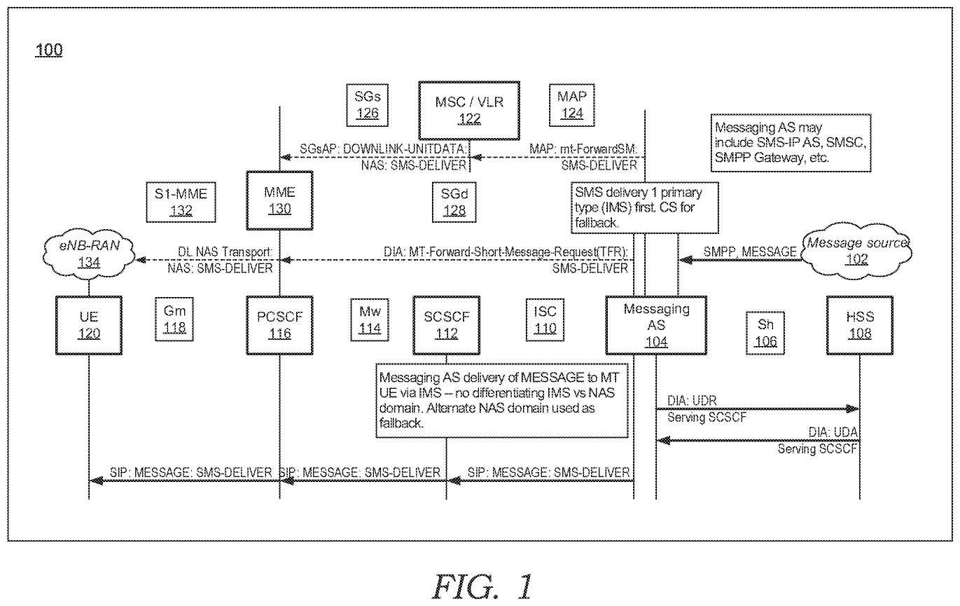

Turning now to FIG. 1, general operating environment 100 is an example operating environment for general network messaging. At a high level, the general operating environment 100 comprises message source 102, messaging application server (AS) 104, Sh diameter interface 106 between the messaging AS 104 and the Home Subscriber Server (HSS) 108, IP multimedia subsystem Service Control interface (ISC) 110 connecting the messaging AS 104 with the Serving Call Session Control Function (SCSCF) 112, Mw interface 114 connecting the SCSCF 112 and the Proxy Call Session Control Function (PCSCF) 116, Gm interface 118 connecting the PCSCF 116 and the UE 120, Mobile Application Part (MAP) interface 124 facilitating communications between the messaging AS 104 and the Mobile Switching Center (MSC)/Visitor Location Register (VLR) 122, SGs interface 126 corresponding to the MSC/VLR 122 and the Mobility Management Entity (MME) 130, SGd interface 128 corresponding to the MSC/VLR 122, MME 130, and the messaging AS 104, S1-MME 132, and eNodeB Radio Access Network (eNB-RAN) 134 corresponding to the S1-MME 132, MME 130 and the UE 120.

As illustrated in general operating environment 100, messaging AS 104 receives a message to be delivered to user device 120 from the message source 102 (e.g., from a mobile originating UE, a transmitting user device). For example, the user device 120 may be a recipient user device. In some embodiments, the message is a short message service (SMS), a short message peer-to-peer protocol (SMPP), or another type of message. In some embodiments, the messaging AS 104 may include an SMS-IP AS, a short message service center (SMSC), an SMPP gateway, etc.

Based on the messaging AS 104 receiving the message to be delivered to user device 120, the messaging AS 104 transmits a user-data-request (UDR) command to the HSS 108 (e.g., via the Sh interface 106). The UDR command can include a diameter header and a session ID, and the request may be for a vendor ID, an authentication session state, an origin host, an origin realm, and a destination host and realm. For example, this UDR command may be for service authorization and access control, restrictions or permissions associated with a subscriber account, policies for usage, billing and charging information, etc. Based on the UDR command, the messaging AS 104 automatically causes the delivery of the message to the UE 120 via internet protocol multimedia subsystem (IMS). To illustrate, the message is delivered to the UE 120 through the SCSCF 112 (and based on the ISC interface 110 between the messaging AS and the SCSCF 112) and PCSCF 116 (and based on the Mw interface 114 between the SCSCF 112 and PCSCF 116 and the Gm interface 118 between the PCSCF 116 and UE 120).

In general operating environment 100, IMS is the default message delivery method, and the messaging AS 104 does not differentiate between IMS and NAS domain, because the NAS domain is utilized as the fallback method for message delivery. For example, the fallback method could be implemented when there is an IMS server failure (e.g., SCSCF 112 or PCSCF 116 failure) or a particular IMS protocol error. For example, the NAS signaling could be used as fallback for an authentication procedure upon the IMS server failure or the particular IMS protocol error. In situations where the IMS server is failing, this NAS signaling could result in increased signaling overhead and latency compared to the IMS default message delivery method for general operating environment 100.

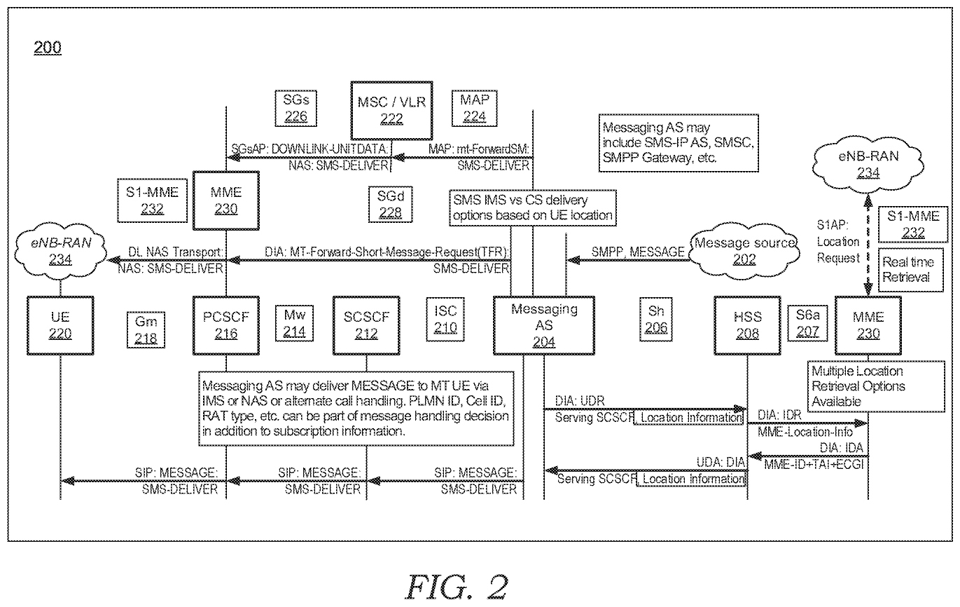

FIG. 2 illustrates example operating environment 200 for network messaging domain selection. At a high level, example operating environment 200 comprises message source 202, messaging AS 204, Sh diameter interface 206 between the messaging AS 204 and the HSS 208, S6a interface 207 between the HSS 208 and MME 230, ISC 210 connecting the messaging AS 204 with the SCSCF 212, Mw interface 214 connecting the SCSCF 212 and the PCSCF 216, Gm interface 218 connecting the PCSCF 216 and the UE 220, MAP interface 224 facilitating communications between the messaging AS 204 and the MSC/VLR 222, SGs interface 226 corresponding to the MSC/VLR 222 and the MME 230, SGd interface 228 corresponding to the MSC/VLR 222, MME 230, and the messaging AS 204, S1-MME 232, and eNB-RAN 234 corresponding to the S1-MME 232, MME 230 and the UE 220.

Example operating environment 200 is but one example of a suitable environment for the technology and techniques disclosed herein, and is not intended to suggest any limitation as to the scope of use or functionality of the invention. Neither should the environment 200 be interpreted as having any dependency or requirement relating to any one or combination of components illustrated. For example, other embodiments of example operating environment 200 may have additional UEs, MMEs, HSSs, messaging sources, ASs, etc. As another example, even though SMS is illustrated as the example message being delivered, other IP-based messaging types may also be delivered based on the retrieval of the particular location information discussed herein.

As illustrated in example operating environment 200, messaging AS 204 receives a message (e.g., SMS, SMPP, etc.) to be delivered to user device 220 (e.g., recipient user device) from the message source 202 (e.g., from a mobile originating UE, a transmitting user device). In some embodiments, the messaging AS 204 may include an SMS-IP AS, SMSC, an SMPP gateway, etc., or one or more combinations thereof. The messaging AS 204 can support messaging services by providing messaging functionality and infrastructure (e.g., by way of communication via particular interfaces with the NAS and IMS domains). For example, the messaging AS 204 can route messages received (e.g., from the message source 202) to user devices (e.g., UE 220) based on determinations made in response to particular queries to the HSS 208.

As indicated above, example operating environment 200 is an example environment for the technology and techniques disclosed herein. For instance, in some embodiments, the operating environment 200 corresponds to a Long Term Evolution (LTE) network environment.

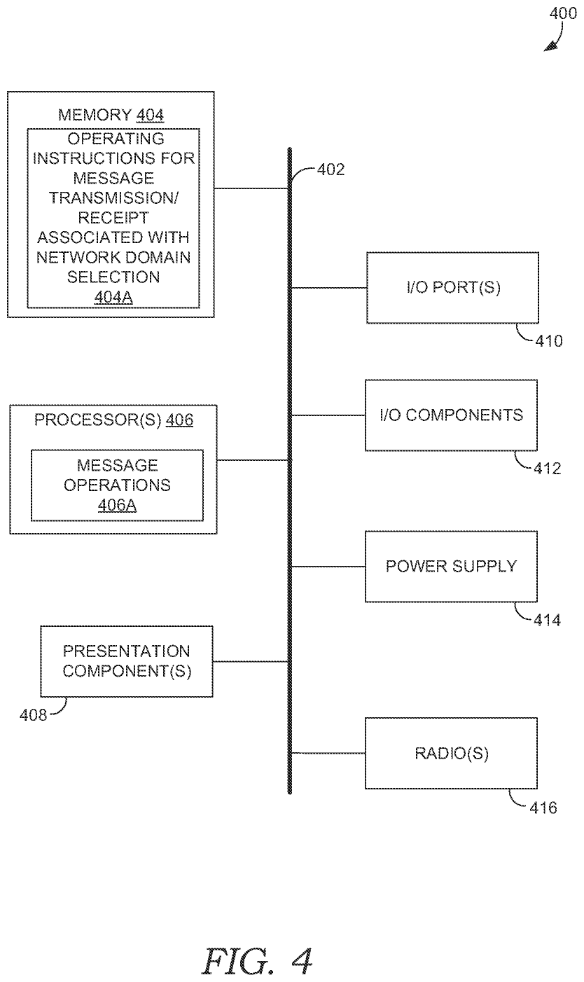

In embodiments, the UE 220 may be a mobile device, smartphone, router, tablet computer, laptop computer, desktop computer, consumer asset locating device, wearable device (e.g., smartwatch, glasses, augmented reality headset, virtual reality headset, extended reality headset, etc.), vehicle (e.g., automobile, motorcycle, bicycle, ship, drone, etc.), a wireless local loop station, an Internet of Things (IoT) device, an Internet of Everything device, a machine type communication device, an evolved or enhanced machine type communication device, another type of user device, or one or more combinations thereof. In some embodiments, the UE 220 may be user device 400 of FIG. 4.

The messaging AS 204 determines whether the message should be delivered via NAS or IMS based on a particular or enhanced query to the HSS 208 for particular location information (e.g., a cell ID associated with UE 220, a base station (e.g., eNB-RAN 234), a radio access technology (RAT) type associated with UE 220, a public land mobile network identity (PLMN ID) associated with UE 220, etc., or one or more combinations thereof). For example, the particular or enhanced query to the HSS 208 may be a Diameter Sh interface query that includes an additional command for the particular location information. As another example, the messaging AS 204 may receive the particular location information from the HSS 208 based on the HSS 208 querying the MME 230 via the S6a 207 interface. For example, MME 230 may receive this particular location information from message source 202 in real-time based on the S1-MME 232.

By way of example, in some embodiments, the query to the HSS 208 may include a particular command or request for a PLMN ID associated with the UE 220, such that the PLMN ID for the UE 220 is retrieved by the HSS 208 using the S6a 207 interface with the MME 230 and based on the MME 230 receiving the associated information for the UE 220 in real-time via the S1-MME 232 and the message source 202. As another example, the query to the HSS 208 may additionally or alternatively include a particular command or request for a PLMN ID associated with another messaging source (e.g., another originating UE). In some embodiments, one or more queries from the messaging AS 204 may include a particular command or request for one or more of a cell ID associated with the UE 220, a cell ID associated with eNB-RAN 234 and the UE 220, a RAT type associated with UE 220, a RAT type associated with eNB-RAN 234 and the UE 220, etc., or one or more combinations thereof.

In some embodiments, the messaging AS 204 transmits an instruction to the IMS domain or the NAS domain based on determining whether the message should be delivered via NAS or IMS. For example, based on the particular location information, the messaging AS 204 may transmit an instruction to the IMS domain, for delivery of the message, over the ISC interface 210. In other instances, based on the particular location information, the messaging AS 204 may transmit an instruction to the NAS domain, for delivery of the message, over the MAP interface 224, the SGd interface 228, or one or more combinations thereof.

For instance, based on the messaging AS 204 querying the HSS 208 with a particular command or request for a PLMN ID associated with the UE 220, the messaging AS 204 may determine that the PLMN ID corresponds to a PLMN ID other than a home PLMN ID and transmit the instruction to the NAS domain for delivery of the message via NAS. As another example, based on querying the HSS 208, the messaging AS 204 may determine that the PLMN ID corresponds to the home PLMN ID and transmit the instruction to the IMS domain for delivery of the message via IMS. In other embodiments, the messaging AS 204 may transmit the instruction to the NAS domain for delivery of the message via NAS based on the PLMN ID of both the messaging source 202 and the UE 220 corresponding to a PLMN ID other than a home PLMN ID.

In embodiments, the base station corresponding to eNB-RAN 234 is a macro base station, a small cell, femtocell, relay base station, another type of RAN access point, or one or more combinations thereof. In some embodiments, the eNB-RAN 234 is a Home eNodeB or a non-Home eNodeB. Accordingly, in some embodiments, the cell ID associated with eNB-RAN 234 and the UE 220 may indicate that the UE 220 has a roaming status (e.g., wherein the eNB-RAN 234 is not a Home eNodeB). In this example, based on messaging AS 204 determining that the UE 220 has the roaming status, the messaging AS 204 can transmit an instruction (e.g., to the MSC/VLR 222 via the MAP interface 224 or to the MME 230 via the SGd interface 228) to deliver the message to the UE 220 via NAS instead of IMS, such that the message is delivered to UE 220 via NAS (e.g., through the MME 230 based on the SGd interface 228 with the messaging AS 204 or based on the MAP 224 interface with the MSC/VLR 222).

As another example, in some embodiments, the cell ID associated with eNB-RAN 234 and the UE 220 may indicate that the UE 220 does not have a roaming status. In this example, based on messaging AS 204 determining that the UE 220 does not have the roaming status, the messaging AS 204 can transmit an instruction (e.g., to the SCSCF 212 via the ISC interface 210) to deliver the message to the UE 220 via IMS, such that the message is delivered to UE 220 via IMS (e.g., through the SCSCF 212 based on the ISC interface 210 with the messaging AS 204 and through the PCSCF 216 based on the Mw interface 214 and the Gm 218 interface).

In some embodiments, the messaging AS 204 may determine that the UE 220 is accessing the network environment (e.g., LTE network environment) via a satellite based on the particular location information retrieved from the HSS 208. By way of example, the messaging AS 204 may determine that the UE 220 is connected using the satellite based on RAT type (e.g., LTE-M(LEO), LTE-M(MEO), LTE-M(GEO), LTE-M(OTHERSAT), etc.). In some embodiments, the messaging AS 204 may receive a first RAT type for UE 220 (e.g., from the HSS 208) and a second RAT type for another UE (e.g., from the HSS 208 or another HSS), wherein a first message from messaging source 202 is to be delivered to the UE 220 and a second message from messaging source 202 (or another messaging source) is to be delivered to the other UE. Based on the first RAT type and the second RAT type, the messaging AS 204 may determine that the first RAT type indicates UE 220 is accessing the network (e.g., core network) via a satellite and that the second RAT type indicates the other UE is accessing the network via terrestrial access point (e.g., a base station). Based on this, the messaging AS 204 may transmit the instruction to deliver the first message to the UE 220 via NAS and another instruction to deliver the second message to the other UE via IMS.

### Example Flowchart

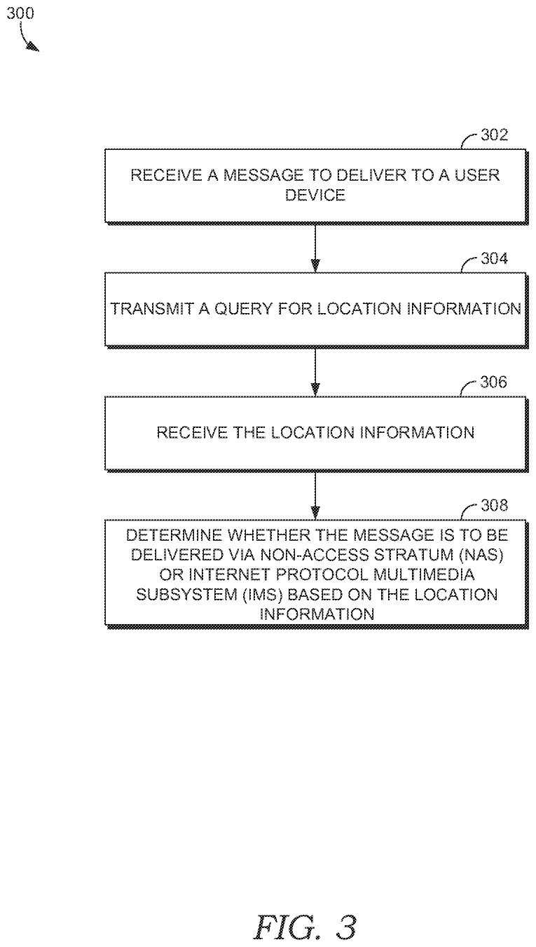

Having described the example embodiments discussed above, an example flowchart is described below with respect to FIG. 3. Example flowchart 300 begins at step 302 with receiving (e.g., by a messaging application server having one or more processors) a message to deliver to a user device. In some embodiments, the message may be a short message service (SMS). In other embodiments, the message may be a rich communication message or another type of message. The message may include message content (e.g., textual information), sender information (e.g., phone number including one or more of a country code, area code, local number, etc.), recipient information (e.g., phone number including one or more of a country code, area code, local number, etc.), message length indicated within the message metadata, a message identifier (e.g., an alphanumeric identifier) within the message metadata, a network provider indicated within the message metadata, etc., or one or more combinations thereof. In some embodiments, a plurality of messages are received for delivery to one or more user devices (e.g., each of the messages to one user device, some of the messages to another user device, etc.).

At step 304, a query is transmitted (e.g., by the messaging application server) to a server (e.g., a Home Subscriber Server (HSS)) for location information (e.g., a cell ID, a radio access technology (RAT) type, a public land mobile network identity (PLMN ID), another type of location information, or one or more combinations thereof). In some embodiments, one or more queries are transmitted to one or more servers for the location information for each of the plurality of messages received that are to be delivered to one or more user devices. For example, a first query can be transmitted to a first HSS for the location information for the first message, and a second query can be transmitted to a second HSS for the location information for the second message. For instance, the messaging application server may receive the location information for the first message from the first HSS and the location information for the second message from the second HSS.

In some embodiments, the query for the location information can be a Diameter Sh interface query (e.g., the one or more queries to the first HSS and the second HSS may each be Diameter Sh interface queries). In embodiments, the Diameter Sh interface query corresponds to an interface between the messaging application server and HSS (or, in addition, the messaging application server and a second HSS, and so forth), wherein the interface is configured to allow the messaging application server to request subscriber profile data from the HSS in real-time. For example, the HSS may be a core network component storing the subscriber profile data (e.g., authentication information, service parameters, subscription status, etc.) for the recipient user device or the transmitting user device. In embodiments, the Diameter Sh interface query corresponds to the Sh interface 206 of FIG. 2. In some embodiments, the query for the location information can cause the HSS to retrieve the location information (e.g., a cell ID, a radio access technology (RAT) type, a public land mobile network identity (PLMN ID), another type of location information, or one or more combinations thereof) from an MME (e.g., MME 230 of FIG. 2).

Based on transmitting the one or more queries, the location information can be received (e.g., by the messaging application server) at step 304, so that the determination as to whether the message is to be transmitted via NAS or IMS can be made at step 306. As one example, based on the location information for a first message, an instruction to deliver the first message via NAS can be transmitted, and based on the location information for a second message, an instruction to deliver the second message via IMS can be transmitted. As another example, the method can, additionally or alternatively, dynamically determining whether a message is to be delivered via NAS or IMS, so that an instruction to deliver at least one of the messages via NAS can be transmitted based on the location information received for that message.

As an example, in embodiments where the location information includes a PLMN ID, the instruction to deliver the message to the recipient user device via NAS can be transmitted based on determining that the PLMN ID (e.g., for the recipient user device of that message) corresponds to a PLMN ID other than a home PLMN ID. As another example, in embodiments where the location information includes a cell ID, the instruction to deliver the message to the user device via NAS can be transmitted based on determining that the cell ID (e.g., corresponding to the recipient user device, the transmitting user device, or both) indicates a roaming status. In some embodiments, the NAS delivery instruction can be transmitted based on determining that the PLMN ID of the recipient device corresponds to the non-home PLMN ID and that the cell ID corresponding to the recipient user device indicates a roaming status. In some embodiments, the NAS delivery instruction can be transmitted based on determining that the PLMN ID of the transmitting device corresponds the non-home PLMN ID and that the cell ID corresponding to the transmitting user device indicates a roaming status. In some embodiments, the NAS delivery instruction can be transmitted based on determining that the PLMN ID of the transmitting device corresponds the non-home PLMN ID and that the cell ID corresponding to the recipient user device indicates a roaming status (e.g., based on querying one or more HSS for the location information for the recipient and transmitting user devices), and so forth.

The PLMN ID may include a mobile country code (MCC) and mobile network code (e.g., having five to six digit numbers identifying a country and a mobile network operator). In embodiments, an HSS may be queried for the MCC corresponding to the recipient user device or transmitting user device, such that the determination that the message should be delivered via NAS can, additionally or alternatively, be based on the MCC (e.g., such that the information location received is determined to indicate a roaming status). In some embodiments, an HSS may also be queried for a location area identity (LAI) for the recipient user device or transmitting user device, which includes the PLMN ID and a location area code, such that the determination that the message should be delivered via NAS can, additionally or alternatively, be based on a location area code or LAI. In some embodiments, an HSS may also be queried for an international mobile subscriber identity (IMSI) for the recipient user device or transmitting user device, which includes the PLMN ID and identifies a subscriber identity module (SIM) or universal SIM (USIM) for a subscriber, such that the determination that the message should be delivered via NAS can, additionally or alternatively, be based on IMSI (or SIM or USIM identified from the IMSI).

The cell ID is a unique identifier (e.g., numerical values, alphanumeric strings) that distinguishes different cells within a network. For example, the cell ID may correspond to a base station and a particular network associated with the recipient user device or transmitting user device. For instance, the cell ID may correspond to an eNodeB ID (e.g., a 20-bit value assigned to a base station) and a physical cell ID (e.g., a 3-bit value) associated with a physical layer for a particular cell within the eNodeB. In some embodiments, the cell ID is a unique identifier that distinguishes cells within a particular PLMN. Accordingly, in some embodiments, the HSS may be queried for a particular cell ID (for the recipient user device or transmitting user device), such that the determination that the message should be delivered via NAS can, additionally or alternatively, be based on the particular cell ID (e.g., and a determination that the recipient user device or transmitting user device is roaming based on the particular cell ID).

In some embodiments, the NAS delivery instruction can be transmitted based on RAT type (e.g., received from the HSS based on a particular query that causes the HSS to provide the RAT type). For example, the RAT type can define one or more technical specifications or protocols for UE connection to the network. For instance, different RAT types may support differing transmission profiles. RAT type may include Long Term Evolution (LTE), New Radio (NR), another RAT type (e.g., a RAT type to be later defined by 3GPP or by a standardization body other than 3GPP), or one or more combinations thereof. Other examples of RAT type may include Universal Terrestrial Radio Access Network (UTRAN), Global system for mobile communication EDGE Radio Access Network (GERAN), Wireless Local Area Network (WLAN), Generic Access Network (GAN), High Speed Packet Access (HSPA) Evolution, Evolved UTRAN (EUTRAN), EUTRAN-NB-IoT, LTE-M, WB-EUTRAN(LEO), WB-EUTRAN (MEO), WB-EUTRAN (GEO), WB-EUTRAN(OTHERSAT), EUTRAN-NB-IoT(LEO), EUTRAN-NB-IoT (MEO), EUTRAN-NB-IoT (GEO), EUTRAN-NB-IoT(OTHERSAT), LTE-M(LEO), LTE-M(MEO), LTE-M(GEO), LTE-M(OTHERSAT), etc. By way of illustration, the NAS delivery instruction can be transmitted based on determining that the recipient or transmitting user device is accessing a particular network via a satellite (e.g., based on the RAT type EUTRAN-NB-IoT(LEO), LTE-M(MEO), WB-EUTRAN(OTHERSAT), etc.). As another example, the NAS delivery instruction can be transmitted based on determining that the recipient or transmitting user device being associated with a particular RAT type (e.g., based on the recipient or transmitting user devices having different RAT types). In yet another illustration, the NAS delivery instruction can be transmitted based on one or more of the RAT type (for the transmitting or recipient user device), PLMN ID, cell ID, etc., or one or more combinations thereof.

Additionally, determinations to transmit a message via IMS instead of NAS can be based on one or more of the RAT type (for the transmitting or recipient user device), PLMN ID, cell ID, etc., or one or more combinations thereof. For instance, based on a second PLMN ID of a second message corresponding to the home PLMN ID (e.g., for the recipient user device), the instruction to deliver the second message via IMS can be transmitted. Additionally or alternatively, the instruction to deliver the second message via IMS can be transmitted based on the cell ID associated with the second message not indicating a roaming status. Additionally or alternatively, the instruction to deliver the second message via IMS can be transmitted based on the second RAT type indicating a particular recipient or transmitting user device associated with the second message is accessing the network (e.g., core network) via a particular base station (e.g., based on a WLAN RAT type) or terrestrial access point.

### Example User Device

Referring now to FIG. 4, a diagram is depicted of an example computing environment suitable for use in implementations of the present disclosure. In particular, the example computer environment is shown and designated generally as user device 400. User device 400 is but one example of a suitable computing environment and is not intended to suggest any limitation as to the scope of use or functionality of the invention. Neither should user device 400 be interpreted as having any dependency or requirement relating to any one or combination of components illustrated.

The implementations of the present disclosure may be described in the general context of computer code or machine-useable instructions (e.g., associated with memory 404), including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 4, user device 400 includes bus 402 that directly or indirectly couples the following devices: memory 404, one or more processors 406, one or more presentation components 408, input/output (I/O) ports 410, I/O components 412, power supply 414 and radio(s) 416. As illustrated in FIG. 4, the memory 404 includes instructions for message transmission/receipt associated with the network domain selection 404A discussed herein, and the one or more processors 406 include message operations 406A corresponding to the message transmission/receipt associated with the network domain selection 404A.

Bus 402 represents what may be one or more busses (such as an address bus, data bus, or combination thereof). Although the devices of FIG. 4 are shown with lines for the sake of clarity, in reality, delineating various components is not so clear, and metaphorically, the lines would more accurately be grey and fuzzy. For example, one may consider a presentation component, such as a display device to be one of I/O components 412. Also, processors, such as one or more processors 406, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 4 and refer to “computer” or “user device.”

User device 400 typically includes a variety of computer-readable media (e.g., associated with memory 404). Computer-readable media can be any available media that can be accessed by user device 400 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media may include, for example, RAM, ROM, EEPROM, flash memory or other memory technology, CD-ROM, DVD or other optical disk storage, magnetic cassettes, magnetic tape, magnetic disk storage, other magnetic storage devices, other types of computer storage media, or one or more combinations thereof.

Computer storage media, as used herein, does not comprise a propagated data signal (i.e., the computer storage media does not comprise signals per se).

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

Memory 404 includes computer-storage media in the form of volatile and/or nonvolatile memory. Memory 404 may be removable, non-removable, or a combination thereof. Exemplary memory includes solid-state memory, hard drives, optical-disc drives, etc. User device 400 includes one or more processors 406 that read data from various entities, such as bus 402, memory 404, or I/O components 412. In some embodiments, the one or more processors 406 include message operations 406A including transmitting a message to deliver to a user device that may be received by a messaging application server for determining whether to deliver the message via non-access stratum (NAS) or internet protocol multimedia subsystem (IMS) based on particular location data associated with the user device 400 or a recipient user device. In some embodiments, the message operations 406A include receiving a message (via NAS or IMS) based on instructions from a messaging application server that determined whether to deliver the message via NAS or IMS based on the particular location data (e.g., associated with the user device 400 or a mobile originating user device).

The one or more presentation components 408 can present data indications to a person or other device. Examples of the one or more presentation components 408 may include a display device, speaker, printing component, vibrating component, etc., or one or more combinations thereof. In some embodiments, the display device or another type of presentation component may display: the message being delivered based on the messaging application server determining whether to deliver the message via NAS or IMS, the message received over NAS or IMS according to the instructions (of how to deliver the message) that the messaging server transmitted, metadata of the message, one or more portions of the instructions associated with the determination on whether to deliver the message via NAS or IMS, etc., or one or more combinations thereof. Further, the I/O ports 410 can allow user device 400 to be logically coupled to other devices, including I/O components 412, some of which may be built in user device 400. Examples of the I/O components 412 may include a microphone, joystick, game pad, satellite dish, scanner, printer, wireless device, etc., or one or more combinations thereof.

Radio 416 represents a radio that facilitates communication with a wireless telecommunications network. Illustrative wireless telecommunications technologies may include CDMA, GPRS, TDMA, GSM, etc., or one or more combinations thereof. Radio 416 might additionally or alternatively facilitate other types of wireless communications, including Wi-Fi, WiMAX, LTE, other VoIP communications, etc., or one or more combinations thereof. As can be appreciated, in various embodiments, radio 416 can be configured to support multiple technologies and/or multiple radios can be utilized to support multiple technologies. A wireless telecommunications network might include an array of devices, which are not shown so as to not obscure more relevant aspects of the invention illustrated within the FIGS. Components, such as a base station, a communications tower, or even access points (as well as other components), can provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

In addition, in the preceding Detailed Description, words such as “a” and “an,” unless otherwise indicated to the contrary, may also include the plural as well as the singular. Thus, for example, the constraint of “a feature” is satisfied where one or more features are present.

Further, the term “or” includes the conjunctive, the disjunctive, and both (a or b thus includes either a or b, as well as a and b).

Furthermore, the term “some” may refer to “one or more.” Additionally, an element in the singular may refer to “one or more.”

The term “plurality” may refer to “more than one.”

In the preceding Detailed Description, “computer storage media” does not comprise signals per se.

The invention claimed is:

1. A system for network messaging domain selection, the system comprising:
one or more processors; and
computer memory storing computer-usable instructions that, when executed by the one or more processors, cause the one or more processors to perform operations comprising:
receiving a message to deliver to a user device;
transmitting a query to a server for location information associated with the message;
based on transmitting the query, receiving the location information; and
based on receiving the location information, transmitting an instruction to a non-access stratum (NAS) server to deliver the message to the user device via NAS.

2. The system according to claim 1, wherein the one or more processors correspond to a messaging application server.

3. The system according to claim 1, wherein the location information includes a public land mobile network identity (PLMN ID), the operations further comprising:
based on receiving the PLMN ID, determining that the PLMN ID corresponds to a PLMN ID other than a home PLMN ID; and
based on the PLMN ID corresponding to the PLMN ID other than the home PLMN ID, transmitting the instruction to deliver the message to the user device via NAS.

4. The system according to claim 1, wherein the server is a home subscriber server (HSS).

5. The system according to claim 4, wherein the query to the HSS is a Diameter Sh interface query.

6. The system according to claim 1, wherein the message is a short message service.

7. The system according to claim 1, wherein the location information includes a cell identity (cell ID) corresponding to a base station and a particular network associated with the user device, the operations further comprising:
based on receiving the cell ID, determining that the cell ID indicates a roaming status; and
based on the cell ID indicating the roaming status, transmitting the instruction to deliver the message to the user device via NAS.

8. The system according to claim 7, wherein the location information includes a radio access technology (RAT) type associated with the user device, the operations further comprising:
based on receiving the location information, determining that the user device is accessing the particular network via a satellite; and
based on determining that the user device is accessing the particular network via the satellite, transmitting the instruction to deliver the message to the user device via NAS.

9. The system according to claim 7, wherein the location information includes a public land mobile network identity (PLMN ID) for the user device, the operations further comprising:
based on receiving the PLMN ID, determining that the PLMN ID for the user device corresponds to a PLMN ID other than a home PLMN ID; and
based on the PLMN ID for the user device corresponding to the PLMN ID other than the home PLMN ID, transmitting the instruction to deliver the message to the user device via NAS.

10. A method for network messaging domain selection, the method comprising:
receiving messages to deliver to one or more user devices;
transmitting one or more queries to one or more servers for location information for each of the messages;
based on the location information for a first message of the messages, transmitting an instruction to deliver the first message via non-access stratum (NAS); and
based on the location information for a second message of the messages, transmitting an instruction to deliver the second message via internet protocol multimedia subsystem (IMS).

11. The method according to claim 10, wherein the location information includes a public land mobile network identity (PLMN ID), the method further comprising:
based on receiving a first PLMN ID for the first message, determining that the first PLMN ID corresponds to a PLMN ID other than a home PLMN ID;
based on receiving a second PLMN ID for the second message, determining that the second PLMN ID corresponds to the home PLMN ID;
based on the first PLMN ID corresponding to the PLMN ID other than the home PLMN ID, transmitting the instruction to deliver the first message via NAS; and
based on the second PLMN ID corresponding to the home PLMN ID,
transmitting the instruction to deliver the second message via IMS.

12. The method according to claim 10, wherein the location information includes a cell identity (cell ID) corresponding to a base station and a particular network, the method further comprising:
based on receiving a first cell ID for the first message, determining that the first cell ID indicates a roaming status; and
based on the first cell ID indicating the roaming status, transmitting the instruction to deliver the first message via NAS.

13. The method according to claim 10, wherein the location information includes a radio access technology (RAT) type, the method further comprising:
based on receiving a first RAT type for the first message, determining that the first RAT type indicates a first user device of the one or more user devices is accessing a core network via a satellite;
based on receiving a second RAT type for the second message, determining that the second RAT type indicates a second user device of the one or more user devices is accessing the core network via a base station;
based on the first RAT type indicating the first user device is accessing the core network via the satellite, transmitting the instruction to deliver the first message to the first user device via NAS; and
based on the second RAT type indicating the second user device is accessing the core network via the base station, transmitting the instruction to deliver the second message to the second user device via IMS.

14. The method according to claim 10, wherein the messages, including the first message and the second message, are each a short message service, and wherein a messaging application server determines to deliver the first message via NAS and the second message via IMS.

15. The method according to claim 14, wherein the location information for the first message is received from a first home subscriber server (HSS) of the one or more servers, the location information for the second message is received from a second HSS of the one or more servers, and wherein the one or more queries to the first HSS and the second HSS are each Diameter Sh interface queries.

16. The method according to claim 15, wherein the location information received from the first HSS and the second HSS includes one or more of a public land mobile network identity, a radio access technology type, and a cell identity.

17. One or more non-transitory computer storage media having computer-executable instructions embodied thereon, that when executed by at least one processor, cause the at least one processor to perform a method for network messaging domain selection, the method comprising:
receiving messages to deliver to one or more user devices;
transmitting one or more queries to a server for location information for each of the messages;
dynamically determining whether each of the messages is to be delivered via non-access stratum (NAS) or internet protocol multimedia subsystem (IMS) based on the location information for each of the messages; and
transmitting an instruction to deliver at least one of the messages via NAS based on the location information for the at least one of the messages.

18. The one or more non-transitory computer storage media of claim 17,
wherein the one or more non-transitory computer storage media correspond to a messaging application server, and the messaging application server determines to deliver the at least one of the messages to a first user device of the one or more user devices via NAS based on the location information including a first RAT type indicating the first user device is accessing a core network via a satellite, and wherein the instruction is transmitted based on the first user device accessing the core network via the satellite.

19. The one or more non-transitory computer storage media of claim 18, further comprising:
dynamically determining that a second message of the messages is to be delivered via IMS based on receiving the location information for the second message that includes a cell ID indicating a status other than a roaming status; and
transmitting an instruction to deliver the second message via IMS based on the cell ID.

20. The one or more non-transitory computer storage media of claim 18, wherein the messaging application server determines to deliver the at least one of the messages to the first user device via NAS based on the location information also including a public land mobile network identity (PLMN ID) and based on determining that the PLMN ID corresponds to a PLMN ID other than a home PLMN ID.
